(19) United States
(12) Patent Application Publication
(10) Pub. No.: US 2005/0018142 A1
(43) Pub. Date: Jan. 27, 2005

(54) Projection system

(75) Inventor: Chan Young Park, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/893,991

(22) Filed: Jul. 20, 2004

(30) Foreign Application Priority Data
Jul. 21, 2003 (JP) P2003-0049750

(51) Int. Cl. G03B 21/00

(52) U.S. Cl. 353/33

(57) ABSTRACT

Disclosed is a projection system including: Red, Green Blue laser light sources; DMDs (Digital Micromirror Devices) for respectively displaying corresponding color images, by using Red, Green and Blue lights emitting from the laser light sources by electrical signals; a prism for synthesizing the color images displayed by the DMDs; first, second and third projection lens systems positioned between the DMDs and the prism; and a fourth projection lens system for magnifying and projecting the synthesized images.

This application claims the benefit of the Korean Application No. P2003-49750 filed on Jul. 21, 2003, which is hereby incorporated by reference.

### BACKGROUND OF THE INVENTION

1. Field of the Invention

The present invention relates to a projection system, and more particularly, to a laser projection system.

2. Discussion of the Related Art

Generally, a projection system is a system for magnifying and projecting a small image to display a large screen.

A liquid crystal display (LCD) projection system is a typical projection system, which uses a lamp and an LCD.

FIG. 1 illustrates a basic construction of the LCD projection system.

As shown in FIG. 1, in the LCD projection system, light, which is generated from a lamp 101, travels in a constant direction by using a reflection mirror.

Next, red light transmits through a red filter 102, and green and blue lights are reflected by the red filter 102.

The transmitting red light is reflected by a red mirror 103, and then irradiated into a red LCD 107. The green light reflected by the red filter 102 is reflected by the blue filter 104, and then irradiated into the green LCD 108, and the blue light transmits through the blue filter 104.

The transmitting blue light is reflected by a first blue mirror 105 and a second blue mirror 106, and then irradiated into a blue LCD 109.

Here, each of the red, green and blue LCDs 107, 108 and 109 displays a corresponding color image using an electrical signal.

Additionally, color images are synthesized using a prism 110. Next, when the synthesized color image is magnified and projected onto a screen 112 using a projection optic system 111, a user can view and enjoy the projected image.

The conventional projection system has a drawback in that since light emitting from the lamp is separated in color using a plurality of color filters and is again synthesized, a ratio of light amounts of red, green and blue constituting a color image should be controlled depending on the lamp.

The above drawback is described with reference to FIG. 2 illustrating a spectrum of the lamp used in the LCD projection system.

As shown in FIG. 2, the LCD projection system uses partial light wavelength areas corresponding to red, green and blue, among the spectrum of the lamp.

However, the light wavelength areas corresponding to red, green and blue are majorities in a total spectrum area. Further, a light amount of a wavelength area corresponding to Green is relatively much, and light amounts of wavelength areas corresponding to Blue and Red are less.

Specifically, since a blue wavelength area having the least visibility is the darkest due to its least light amount, a white balance is adjusted by reducing the light amounts of Green and Red adaptively to the light amount of Blue, so as to provide the color image corresponding to an input image signal.

The conventional projection system has a drawback in that a light efficiency is reduced due to the use of only a part of the lamp and the reduction of a light amount of a specific color for adaptation of the white balance.

Further, the conventional projection system has a drawback in that it is difficult to reproduce the pure color close to the natural color due to a wide wavelength area expressing color.

### SUMMARY OF THE INVENTION

Accordingly, the present invention is directed to a projection system that substantially obviates one or more problems due to limitations and disadvantages of the related art.

An object of the present invention is to provide a projection system in which laser is used as a light source to embody a high quality of image, and a back focal length of a projection lens is reduced to provide a short conjugation length, thereby providing a compact construction.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a projection system including: red, green blue laser light sources; DMDs (Digital Micromirror Devices) for respectively displaying corresponding color images, using red, green and blue lights emitting from the laser light sources by electrical signals; a prism for synthesizing the color images displayed by the DMDs; first, second and third projection lens systems positioned between the DMDs and the prism; and a fourth projection lens system for magnifying and projecting the synthesized images.

The prism is an X-cube prism.

The first, second and third projection lens systems are comprised of at least one lens.

The light generated from the laser light source is reflected toward the DMD by a total reflection prism.

The light reflected by the DMD transmits through the total reflection prism to travel toward the first, second and third projection lenses.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a construction of a conventional LCD projection system;

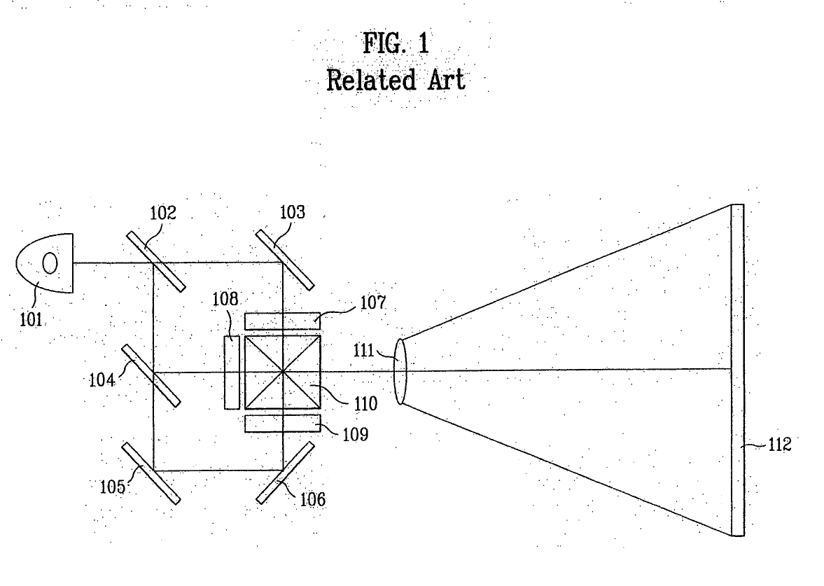

FIG. 2 illustrates a lamp spectrum of a conventional LCD projection system;

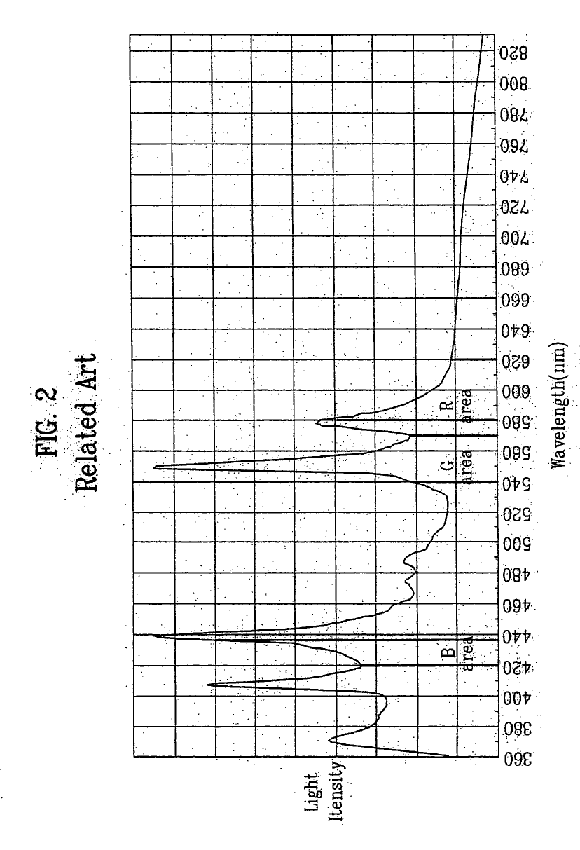

FIG. 3 illustrates a construction of a laser projection system according to a preferred embodiment of the present invention;

FIG. 4 illustrates a color synthesizing method using an X-cube prism of a laser projection system according to a preferred embodiment of the present invention; and

FIG. 5 illustrates a construction of a projection lens and a relation of a back focal length according to a preferred embodiment of the present invention.

### DETAILED DESCRIPTION OF THE INVENTION

Reference will now be made in detail to the preferred embodiments of the present invention, examples of which are illustrated in the accompanying drawings.

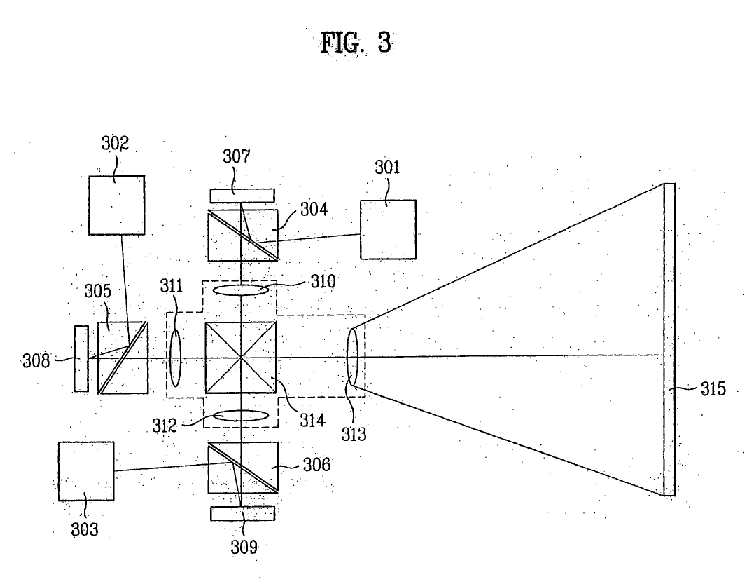

FIG. 3 illustrates a construction of a laser projection system according to a preferred embodiment of the present invention.

As shown in FIG. 3, the laser projection system includes red, green and blue laser light sources 301, 302 and 303; red, green and blue total internal reflection (TIR) prisms 304, 305 and 306 for total-reflecting laser light generated from the laser light sources 301, 302 and 303; and red, green and blue digital micromirror devices (DMD) 307, 308 and 309 for adjusting a light amount of the total-reflected red, green and blue lights by an image signal of each corresponding color and reflecting at a specific angle, to display an image.

Further, the laser projection system includes first, second and third projection lens systems 310, 311 and 312 respectively disposed at the light outputting sides of the red, green and blue DMDs 307, 308 and 309; an X-cube prism 314 for synthesizing images provided from the red, green and blue DMDs 307, 308 and 309; a fourth projection lens system 313 for magnifying and projecting the synthesized images; and a screen 315 for imaging the projected images.

The laser projection system according to the present invention is operated as in the following principle.

First, red, green and blue laser lights emit from the red, green and blue lasers 301, 302 and 303 that are the light sources.

Next, the emitting red, green and blue laser lights are respectively incident onto the red, green and blue TIR prisms 304, 305 and 306.

The total internal reflection prisms 304, 305 and 306 are constructed with two prisms being junctioned using minute air gap interposed therebetween.

Here, the incident laser lights are totally reflected by reflection surfaces, which are formed at specific angles, of the Red, Green and Blue total reflection prisms 304, 305 and 306, and then irradiated into the red, green and blue DMDs 307, 308 and 309.

After that, the red, green and blue DMDs 307, 308 and 309 adjust the light amount at each of pixels by the image signal to provide each of the corresponding color images, and reflects the color light at a specific angle.

The DMD is popular since it provides more bright and natural image than an LCD due to its faster response speed, higher contrast and higher reflective rate.

The DMD is an array of ten thousands to millions of micrometer mirrors used through a semiconductor process. The DMD controls angles of the mirrors by using voltages applied to the mirrors to control image information of each pixel.

Next, the color image reflected by the DMD transmits through the total internal reflection prisms 304, 305 and 306 to travel as it is.

After that, the color image transmits through the first, second and third projection lens systems 310, 311 and 312, and then is vertically incident on the X-cube prism 314 for synthesizing.

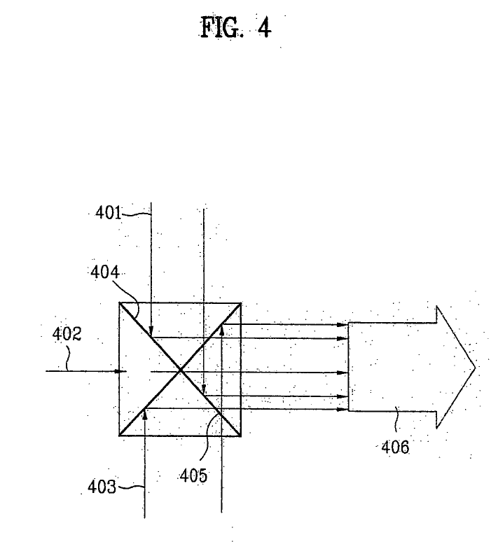

A light synthesizing process of the X-cube prism is described in detail with reference to FIG. 4 as follows.

As shown in FIG. 4, a red light 401 is incident on the X-cube prism 404 and reflected by an internal Red reflective surface 404 to travel toward the fourth projection lens system 313.

Further, a blue light 403 is reflected by an internal Blue reflective surface 405 of the X-cube prism 314 to travel toward the fourth projection lens system 313.

Alternatively, a green light 402 transmits through the X-cube prism 314 as it is, without reflecting from the internal reflective surface of the X-cube prism 314, to travel toward the fourth projection lens system 313.

The red, green and blue lights are synthesized through the X-cube prism 314 by using the above-mentioned method, and are converted into a white light 406.

After that, the color image synthesized in the X-cube prism 314 is magnified and projected by the fourth projection lens system 313, and is then imaged on the screen 315.

Here, the first, second and third projection lens systems 310, 311 and 312 can be comprised of one or more lenses, and the number of the lenses is determined by a relation of a light power distribution with the fourth projection lens 313.

If the laser light is used as the light source of the projection system, the present invention can express a pure color close to a natural color. Since a light amount of a different color needs to be controlled depending on a light amount of a specific color, the present invention can increase a light efficiency.

Further, since the present invention does not need to separate light generated from a conventional lamp into Red, Green and Blue lights, it does not need a light separating means. The present invention can solve a drawback in which the lamp has an explosion danger and a short life caused by a highly pressurized internal construction and a high voltage driving.

Furthermore, the present invention uses the first, second and third projection lens systems 310, 311 and 312 to provide a short conjugation length, and compactly constructs the projection system to improve a picture quality of image.

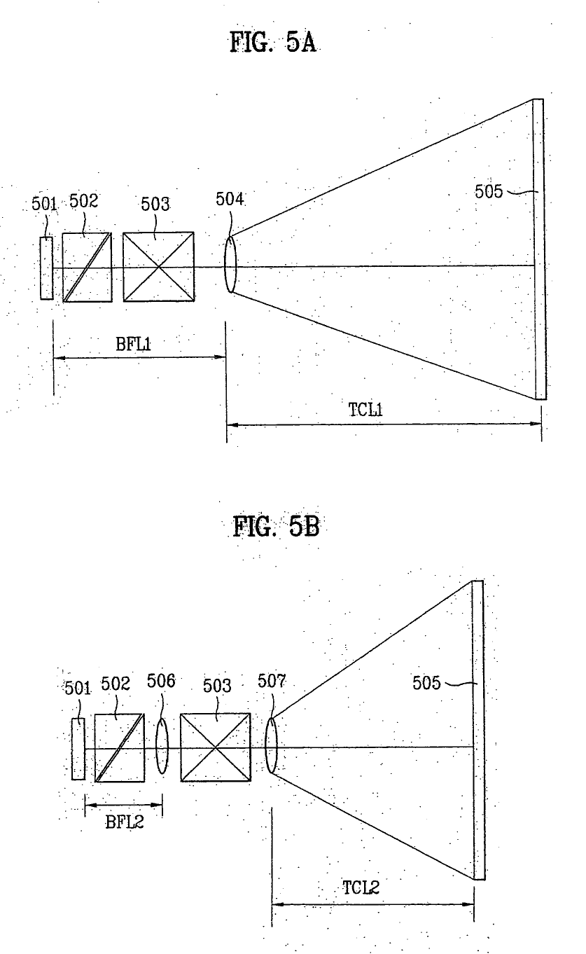

A principle of using the first, second and third projection lens systems to improve a performance of projection is described with reference to FIG. 5 in the following.

FIG. 5 illustrates a construction of a projection lens and a relation of a back focal length according to a preferred embodiment of the present invention.

FIG. 5A illustrates a projection lens system not including the prism, and FIG. 5B illustrates a projection lens system including the prism. Here, for description convenience, a green light path is exemplified as a portion of the projection system.

As shown in FIG. 5A, if a total internal reflection prism 502 and a X-cube prism 503 are disposed between a DMD 501 and a projection lens system 504, a back focal length BFL1 is much increased.

Accordingly, a total conjugation length TCL1 is increased in proportion to the magnification of the projection lens and correspondingly to the back focal length.

This is in detail described as follows.

If a DMD 501 and a screen 505 are determined in size, the projection lens is determined in magnification.

At this time, if the projection lens system 504 is constantly fixed in magnification, the conjugation length is increased as a length from the DMD 501 to the projection lens system 504 is increased.

That is, if the BFL1, which is a length from the DMD 501 to a first lens surface of the projection lens system 504, is increased, the TCL1 is increased in proportion to the magnification of the projection lens. Then, a whole size of the projection system becomes very large.

Further, since a retro ratio, which is a ratio of the BFL1 to the focal length of the projection lens system 504, is much increased, the projection lens system 504 is reduced in performance.

This results in deterioration of a picture quality of the image that is imaged on a screen 505.

Accordingly, as shown in FIG. 5B, a second projection lens system 506 corresponding to the green light is disposed between the total internal reflection prism 502 and the X-cube prism 503.

Then, since the projection system begins to project from the second projection lens system 506, a BFL2 is much reduced.

Further, a TCL2, which is a length from a fourth projection lens system 507 to the screen 505, is reduced in proportion to the magnification of the projection lens.

As mentioned above, the conjugation length can be reduced to compactly construct the whole projection system.

Furthermore, the retro ratio of the projection lens is reduced to improve the performance of the projection lens, thereby improving the picture quality of the image imaged on the screen.

The above-described inventive projection system has the following effects.

First, the laser is used as the light source to increase color purity, and provide a natural and clear color image. Further, the light efficiency of the light source is increased, and a bright and clear high quality of image is provided.

Second, the back focal length of the projection lens is reduced to provide the short conjugation length, thereby compactly constructing the projection system.

It will be apparent to those skilled in the art that various modifications and variations can be made in the present invention. Thus, it is intended that the present invention covers the modifications and variations of this invention provided they come within the scope of the appended claims and their equivalents.

1. A projection system comprising:
red, green blue laser light sources;
DMDs (Digital Micromirror Devices) for respectively displaying corresponding color images using red, green and blue lights emitting from the laser light sources by electrical signals;
a prism for synthesizing the color images displayed by the DMDs;
first, second and third projection lens systems positioned between the DMDs and the prism; and
a fourth projection lens system for magnifying and projecting the synthesized images.

2. The system as claimed in claim 1, wherein the prism is an X-cube prism.

3. The system as claimed in claim 1, wherein the first, second and third projection lens systems are comprised of at least one lens.

4. The system as claimed in claim 1, wherein the light generated from the laser light source is reflected toward the DMD by a total reflection prism.

5. The system as claimed in claim 1, wherein the light reflected by the DMD transmits through the total reflection prism to travel toward the first, second and third projection lenses.
